(19) United States
(12) Patent Application Publication
(10) Pub. No.: US 2021/0148678 A1
(43) Pub. Date: May 20, 2021

(54) DETERRENT SPRAYER DEVICE AND SYSTEM

(71) Applicant: Mason Cox, North Salem, IN (US)

(72) Inventor: Mason Cox, North Salem, IN (US)

(21) Appl. No.: 16/685,598

(22) Filed: Nov. 15, 2019

(51) Int. Cl. F41H 9/10; E06B 7/28; E05G 5/00

(52) U.S. Cl. CPC F41H 9/10; E05G 5/003; E06B 7/28

(57) ABSTRACT

A deterrent sprayer device and system includes a sprayer device disposed through a solid barrier such as a door and one or more cannisters of chemical deterrent such as oleoresin capsicum. A user on one side of the barrier screws a cannister into the sprayer device which pierces the cannister and sprays the chemical deterrent on the other side of the barrier at a potential intruder without having to open the barrier.

### TECHNICAL FIELD

The present disclosure relates generally to security devices and systems, more particularly, to devices and systems for delivering chemical deterrents through doors and other solid surfaces.

### BACKGROUND

A variety of defenses and deterrents have been developed for dealing with forced entry and active shooter situations. Most of these defenses involve responses which are active only after an intruder has breeched a safe space such as a room or house. Such responses increase the potential for harm to a user as they are not active until after an intruder has overcome the first line defense, that is, a door. For instance, U.S. Pat. No. 5,402,000 to Owens (“Owens”) discloses a system which sprays a chemical deterrent at an intruder. The Owens's system activates only after an intruder has opened a door and at least partially entered a room. There remains a need for an active system which deters an intruder prior to breeching a door and gaining entry to a space.

### SUMMARY OF THE INVENTION

In one aspect, a chemical deterrent delivery device for deterring potential intruders includes a first faceplate mounted to a barrier such as a door and having a first opening, a second faceplate mounted to the opposite side of a door and having a second opening, and a connecting tube operationally connecting the first faceplate to the second faceplate through the door and containing a piercing device. The opening of the first faceplate is threaded to accept and threadably engage a storage bottle containing one or more chemical deterrents under pressure. When the storage bottle is threadably engaged with the opening of the first faceplate the piercing device pierces the storage bottle which releases the one or more chemical deterrent which travels through the connecting tube and is dispensed from the opening in the second faceplate.

In another aspect, a chemical deterrent delivery system includes a spray device first faceplate having a threaded first opening, a second faceplate having a second opening, and a connecting tube operationally connecting the first faceplate to the second faceplate and having a piercing device disposed therein. The chemical deterrent delivery system further includes a pressurized deterrent storage bottle having a threaded neck portion sized and adapted to be threadably engaged with the first opening and a cap portion capable of being pierced by the piercing device. Threading the deterrent storage bottle into the threaded first opening pierces the cap portion with the piercing device and releases one or more chemical deterrent agents which travel through the connecting tube and out of the second opening in the second faceplate.

In still another aspect, a method of delivering a chemical deterrent includes engaging a pressurized bottle containing a chemical deterrent with a first faceplate mounted to one side of a door, piercing the pressurized bottle with a piercing device thereby dispensing chemical deterrent from the pressurized bottle, dispensing chemical deterrent through a connecting tube operationally connected to the first faceplate, and dispensing chemical deterrent through a second faceplate operationally connected to the connecting tube into a target area.

### BRIEF DESCRIPTION OF THE DRAWINGS

FIG. 1 is a diagrammatic side view of a deterrent spray device, according to one embodiment;

FIG. 2 is a diagrammatic close up view of a deterrent spray device, according to the embodiment shown in FIG. 1;

FIG. 3 is a diagrammatic side view of a deterrent spray device, according to one embodiment;

FIG. 4 is a diagrammatic side view of a deterrent spray cannister, according to one embodiment;

FIG. 5 is a partially exploded diagrammatic side view of a deterrent spray device, according to one embodiment;

FIG. 6 is a diagrammatic side view of a deterrent spray device, according to one embodiment;

FIG. 7 is a diagrammatic side view of a deterrent spray cannister and adapter, according to one embodiment;

FIG. 8 is a partially exploded diagrammatic side view of a deterrent spray device, according to another embodiment;

FIG. 9 is a diagrammatic side view of a deterrent spray device, according to still another embodiment;

FIG. 10 is a diagrammatic side view of a deterrent spray device in use, according to the embodiment shown in FIG. 9.

### DETAILED DESCRIPTION

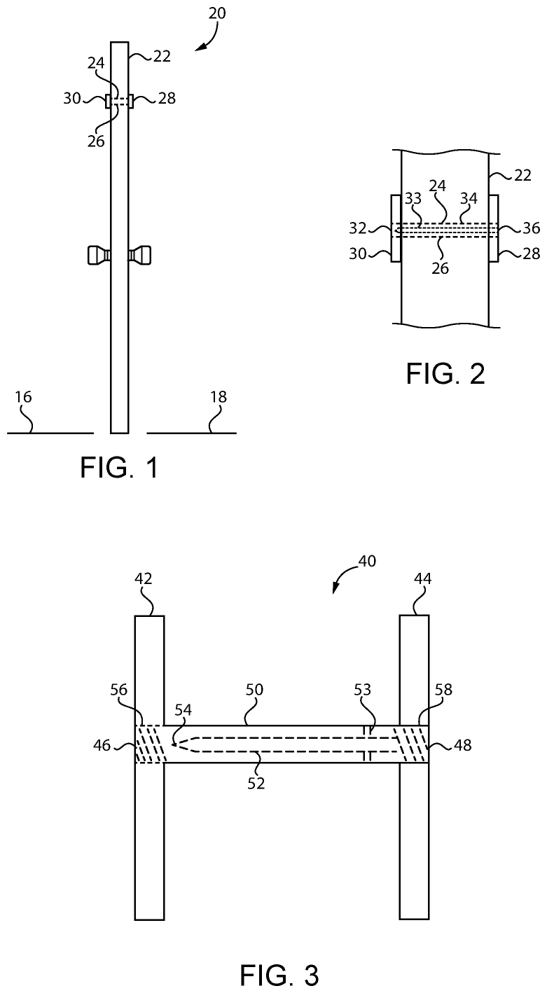

Referring now to FIG. 1, a diagrammatic side view of a deterrent spray system 20 according to one embodiment. In this example, a door 22 acts as a barrier between a safe space 16 and a target space 18. A spray device 24 having a first faceplate 28 mounted to a first side of door 22 and a second faceplate 30 mounted to a second, opposite side of door 22 joined by a connecting tube 26 which passes through door 22. A closeup view of spray device 24 is shown in FIG. 2. First faceplate 28 includes a first opening 36 and a piercing device 33. Second faceplate 30 includes a second opening 32 and a connecting tube body 34. Connecting tube body 34 passes through door 22 and securely connects first faceplate 28 to second faceplate 30. Connecting tube body 34 also operationally connects first opening 36 with second opening 32 such that a chemical deterrent or other substance entering second opening 32 passes through connecting tube body 34 and is delivered into target area 18 through first opening 36.

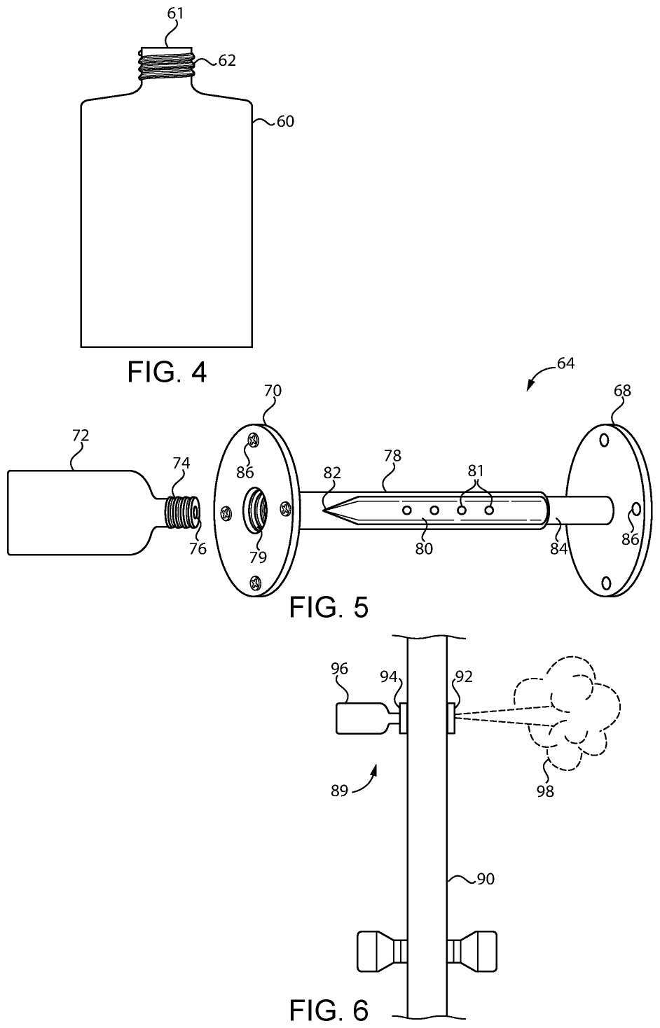

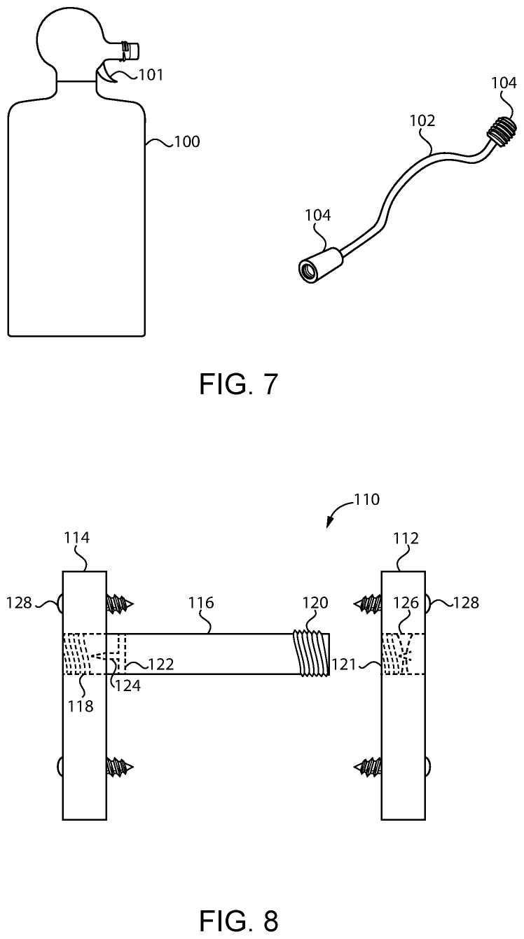

FIG. 3 is a diagrammatic side view of a deterrent spray device 40 according to another embodiment. Spray device 40 includes a first faceplate 42 and a second faceplate 44 operationally connected by a connecting tube 50. First faceplate 42 has a first opening 46 which includes a threaded portion 56. Threaded portion 56 is sized and configured to threadably engage with a deterrent storage bottle 60 containing a chemical deterrent under pressure such as shown in FIG. 4. Second faceplate 44 has a second opening 48 which includes a threaded portion 58. Threaded portion 58 is sized and configured threadably engage with connecting tube 50. Spray device 40 may be installed in a barrier such as a door by first drilling a hole through the door, passing the connecting tube 50 therethrough, and threading and tightening second faceplate 44 onto connecting tube 50. Connecting tube 50 may be produced in a variety of lengths to accommodate doors of different thicknesses. Optionally, connecting tube 50 may be designed to be cut to a desired length to accommodate a particular door thickness. Connecting tube 50 further includes a piercing device 52 held in place by a piercing support 53 and having a piercing tip 54. Piercing device 52 is positioned in connecting tube 50 such that when the threaded neck portion 62 of a deterrent storage bottle 60 is threaded into first opening 46 piercing tip 54 pierces cap 61 of storage bottle 60 thereby dispensing under pressure a deterrent chemical into connecting tube 50. Piercing support 53 includes one or more openings which allows deterrent chemical to pass therethrough and be dispensed through second opening 48.

Referring now to FIG. 5, and alternative embodiment of a deterrent spray device 64 is shown. In this example deterrent spray device 64 includes a first faceplate 70 and a second faceplate 68. First faceplate 70 has a plurality of fastener openings 86 as well as a connecting tube 78 with a threaded opening 79. Threaded opening 79 is sized and configured to accept the threaded neck 74 of a deterrent storage bottle 72. Second faceplate 68 has a plurality of fastener openings 86 as well as a hollow piercing device 80. Piercing device 80 includes a plurality of vent holes 81 such that fluids entering connecting tube 78 pass through vent holes 81 and are exit from second faceplate 68. Piercing device 80 further includes a piercing tip 82 which is positioned such that when deterrent storage bottle 72 is screwed into threaded opening 79 piercing tip 81 pierces cap 76 of storage bottle 72. Once pierced, the pressurized chemical deterrent stored in bottle 72 passes through connecting tube 78, through vent openings 81, down the interior of piercing device 84 and is ejected through second faceplate 68. This particular embodiment allows for connecting tube 78 to slidably engaged with piercing device 80 so as to allow spray device 64 to be installed on doors of different thicknesses.

As seen in FIG. 6 a deterrent spray system 89 having a first faceplate 94 and a second faceplate 92 is installed in a door 90. When deterrent storage bottle 96 is engaged with first faceplate 94 chemical deterrent 98 is deployed from second faceplate 92 to the opposite side of the door 90 from the bottle 96 and first faceplate 94. In this example the deployed deterrent 98 is shown dispersed as a cloud. In other examples, the deployed deterrent may be dispersed as a stream. Typically if the area on the dispersal side of a door or other barrier is more open, for example a walkway, exterior of a building, or large room, then a jet or stream dispersal pattern may be more desirable as it is less likely to be dissipated by wind or other air movement. If the area on the dispersal side of a door or other barrier is more of an enclosed space, such as a hallway or room, then a cloud dispersal pattern may be more desirable as it is more likely to fill the area and contact and deter a potential intruder. Nozzles which produce a desired dispersal pattern may optionally be disposed within a connecting tube.

Optionally, a pressurized deterrent storage bottle 100 having a trigger 101 which allows for selective starting and stopping of chemical deterrent dispensing may be used in combination with any of the systems disclosed herein. In some instances, an adapter 102 having fittings 104 may also be used so that deterrent storage bottles not specifically designed for a particular system disclosed herein may still be used. The fittings 104 are sized and configured so as to allow a particular deterrent storage bottle to be connected via the adapter 102 to a deterrent sprayer system. The adapter 102 may be of any desired length.

Referring to FIG. 8, a partially exploded diagrammatic side view of a deterrent spray device 110 having a first faceplate 114 and a second faceplate 112 is shown. First faceplate 114 has a connecting tube 116 with a threaded opening 118 and a threaded portion 120. Disposed within connecting tube 116 is a piercing tip 124 which is supported by a piercing tip support 122. Piercing tip 124 is positioned such that when a deterrent bottle is threadably engaged with threaded opening 118 the tip pierces the deterrent bottle and allows for the dispensing of deterrent therefrom. First faceplate 114 further includes one or more fasteners 128 such as screws for securing the faceplate to a barrier such as a door.

Second faceplate 112 includes a threaded opening 121 sized and configured to threadably engage threaded portion 120 of connecting tube 116. Second faceplate 112 further includes a nozzle body 126 disposed within threaded opening 121 such that deterrent passing through opening 121 is dispersed in a desired pattern (e.g., a stream or a cloud). Second faceplate 112 further includes one or more fasteners 128 for securing the faceplate to a barrier such as a door.

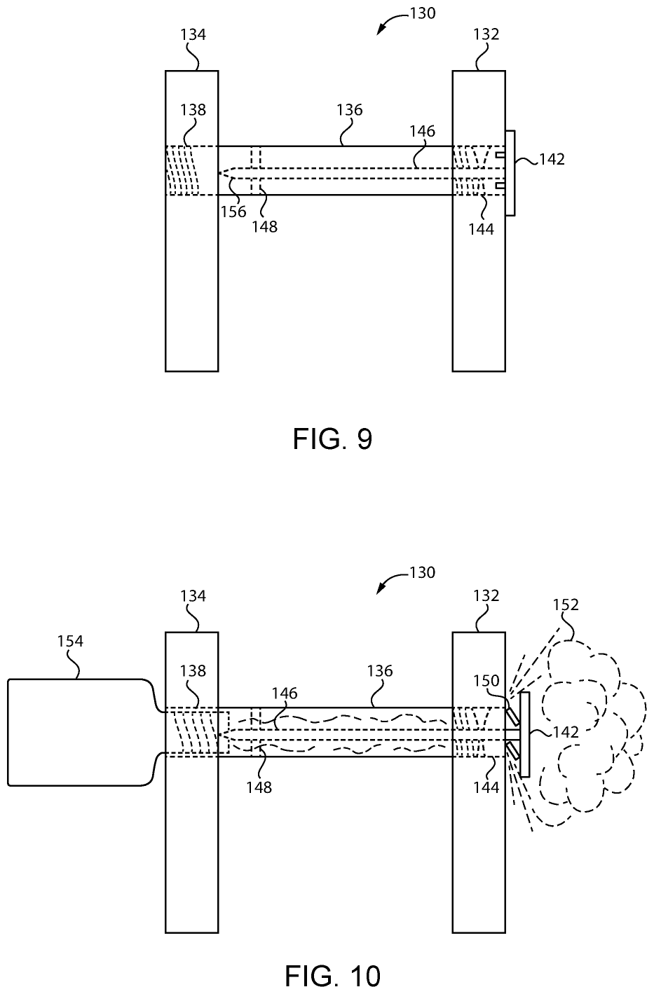

Referring now to FIGS. 9-10 which show a diagrammatic side view of a deterrent spray device 130 according to another embodiment. The deterrent spray device 130 includes a first faceplate 134 and a second faceplate 132 operationally connected by a connecting tube 136. First faceplate 134 includes a threaded opening 138 sized and configured to threadably engage and hold the threaded neck of a deterrent storage bottle 154. Connecting tube 136 includes a piercing device 146 secured in place by a piercing support device 148 such that when a deterrent storage bottle 154 is threadably engaged with first faceplate 134 the bottle is pierced by a piercing tip 156 as shown in FIG. 10. Second faceplate 132 includes an opening 150 which is covered by a movable cover 142. The cover 142 is held in a closed position (FIG. 9) by a biasing member 144 such as a spring. Pressure from chemical deterrent 152 within the connecting tube 136 urges the opening cover 142 into the open position (FIG. 10) and compresses the biasing member 144. Once the pressure in connecting tube 136 drops the biasing member 144 closes the cover 142. Optionally, cover 142 may lock in an open position once forced open. A movable cover such as shown in FIGS. 9-10 prevents potential intruders or people in institutional settings such as prisoners from damaging or obstructing an opening so as to prevent proper dispersal of deterrent.

In the preceding examples the disclosed deterrent spray devices and systems were shown in use with doors, but in other examples deterrent spray devices and systems may be used in conjunction with other barriers such as walls, movable panels, barricades, and other structures which separate one area from another. The disclosed devices and systems may be used in any setting where a barrier separates a threat or potential threat from an area of safety. For example, such a system may be installed in classroom doors so that during an active shooter situation teachers and students may remain locked in a classroom while deterring a shooter located outside the classroom. Similar applications include homes, apartments, hotel rooms, offices, panic rooms, and the like as well as movable enclosed areas such as cars, busses, motor homes, and other vehicles. In some such applications a deterrent container may be threaded into a sprayer system and activated then left to dispense automatically while a user retreats to an interior room putting even more doors and barricades between them and a potential intruder.

Other applications may include institutional settings such as prisons. In such settings the safe side of a door or barrier would be outside of a room and the target area would be inside of a room such as a holding area, cell, and the like. In such applications the volume of the target area is known so the required volume of chemical deterrent may be calculated and deterrent containers filled with a predetermined amount of deterrent sufficient to subdue anyone inside the target area. Use of precalculated amounts of deterrent chemicals reduces the risk of overapplication while still ensuring occupants of the target area are pacified. Such a system could also be adapted for use in movable enclosures as well such as busses and the like.

The disclosed deterrent spray devices and systems may be adapted for use with a variety of chemical deterrents such as oleoresin capsicum (frequently referred to as “OC” or “pepper spray”), 2-chlorobenzalmalononitrile (CS gas), pelargonic acid vanillylamide (PAVA gas), phenacyl chloride (CN gas), and other lachrymator agents and combinations thereof. Deterrent sprays may also include dyes or other marking agents which allow for later identification of a potential intruder. Different formulations and concentrations of deterrent chemicals may also be used such as gels, aerosols, liquids, and the like and they may be dispersed in different forms such as jets, clouds, and fogs, as desired.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. For instance, tray 10 could be equipped with one or more peel-away coverings that could be selectively removed during use, such as where tray 10 is used without form block 14. It will be appreciated that certain features and/or properties of the present disclosure, such as relative dimensions or angles, may not be shown to scale. As noted above, the teachings set forth herein are applicable to a variety of different assemblies, devices, systems, and methods like having or employing a variety of different structures than those specifically described herein. Other aspects, features, and advantages will be apparent upon an examination of the attached drawings and appended claims. As used herein, the articles “a” and “an” are intended to include one or more items, and may be used interchangeably with “at least one.” Where only one item is intended, the term “one” or similar language is used. Also, as used herein, the terms “has,” “have,” “having,” or the like are intended to be open-ended terms.

What is claimed is:

1. A deterrent delivery device, comprising:
a first faceplate having a threaded first opening;
a second faceplate having a second opening; and
a connecting tube operationally connecting the first faceplate to the second faceplate and having a piercing device disposed therein.

2. The deterrent delivery device of claim 1, wherein the threaded first opening is sized and configured to threadably receive a deterrent storage bottle.

3. The deterrent delivery device of claim 2, wherein the piercing device is disposed such that the piercing device pierces a deterrent storage bottle received in the threaded first opening.

4. The deterrent delivery device of claim 1, wherein the connecting tube is threadably engaged with the second faceplate.

5. The deterrent delivery device of claim 1, further comprising a nozzle body disposed within the second opening.

6. The deterrent delivery device of claim 5, wherein the nozzle body is configured to produce a jet spray pattern when a fluid is passed therethrough.

7. The deterrent delivery device of claim 5, wherein the nozzle body is configured to produce a cloud spray pattern when a fluid is passed therethrough.

8. The deterrent delivery device of claim 1, wherein the first faceplate and the second faceplate each include at least one fastener opening.

9. The deterrent delivery device of claim 1, wherein the first faceplate and the second faceplate are mountable to a door.

10. A deterrent delivery system, comprising:
a spray device having a first faceplate having a threaded first opening, a second faceplate having a second opening, and a connecting tube operationally connecting the first faceplate to the second faceplate and having a piercing device disposed therein; and
a pressurized deterrent storage bottle having a threaded neck portion sized and adapted to be threadably engaged with the first opening and a cap portion capable of being pierced by the piercing device;
wherein the cap portion is pierced by the piercing device when the deterrent storage bottle is threadably engaged with the first opening.

11. The deterrent delivery system of claim 9, wherein the deterrent storage bottle contains one or more of: oleoresin capsicum, 2-chlorobenzalmalononitrile, pelargonic acid vanillylamide, phenacyl chloride, and a dye.

12. The deterrent delivery system of claim 9, further comprising a nozzle body disposed within the second opening.

13. The deterrent delivery system of claim 11, wherein the nozzle body is configured to produce a jet spray pattern when a fluid is passed therethrough.

14. The deterrent delivery device of claim 11, wherein the nozzle body is configured to produce a cloud spray pattern when a fluid is passed therethrough.

15. The deterrent delivery device of claim 11, wherein the first faceplate and the second faceplate are mountable to a door.

16. A method of delivering a chemical deterrent, comprising:
engaging a pressurized bottle containing a chemical deterrent with a first faceplate mounted to one side of a door;
piercing the pressurized bottle with a piercing device thereby dispensing chemical deterrent from the pressurized bottle;
dispensing chemical deterrent through a connecting tube operationally connected to the first faceplate;
dispensing chemical deterrent through a second faceplate operationally connected to the connecting tube into a target area.

17. The method of claim 16, wherein the target area is a room.

18. The method of claim 16, wherein the chemical deterrent is selected from the group: oleoresin capsicum, 2-chlorobenzalmalononitrile, pelargonic acid vanillylamide, phenacyl chloride, a dye, and combinations thereof.
